(19) United States
(12) Patent Application Publication
(10) Pub. No.: US 2019/0266902 A1
(43) Pub. Date: Aug. 29, 2019

(54) METHOD AND SYSTEM FOR GENERATING A GRID MAP THAT SHOWS AIR TRAFFIC INTENSITY

(71) Applicant: HONEYWELL INTERNATIONAL INC., Morris Plains, NJ (US)

(72) Inventors: Karol Molnar, Kanice (CZ); Stanislav Foltan, Slovakia (CZ)

(73) Assignee: HONEYWELL INTERNATIONAL INC., Morris Plains, NJ (US)

(21) Appl. No.: 15/904,608

(22) Filed: Feb. 26, 2018

(51) Int. Cl. G08G 5/00

(52) U.S. Cl. CPC G08G 5/0073; G08G 5/0039; G08G 5/0026; G08G 5/0021; G08G 5/0043

(57) ABSTRACT

Methods are provided for generating a grid map that shows aircraft traffic intensity. The method comprises collecting position data and an associated flight plan for each aircraft within a defined airspace volume. Next, each aircraft is modeled based on the latest observed position and the flight plan of the aircraft. The defined airspace volume is divided into a cubic grid pattern with defined spatial and time resolution periods. Each aircraft is assigned a cube within the grid based on the aircraft's modeled movement over future time periods. The number of assigned aircraft is calculated for each cube of the grid over future time periods. A ratio is calculated for the value of the number of assigned aircraft to a pre-determined capacity for each cube. Finally, the suitability of the defined airspace volume for planned aircraft traffic is determined based on the ratios for each cube within the defined airspace volume.

### TECHNICAL FIELD

The present invention generally relates to aircraft and air traffic operations, and more particularly relates to generating a grid map for a defined airspace volume that shows aircraft traffic intensity.

### BACKGROUND

As aircraft traffic density increases, flight planning and trajectory optimization for individual flights become more important. This is especially true with respect to constraints such as weather conditions, published airspace restrictions, etc. which can have a major impact on flight planning. Also, maintaining separation between aircraft is essential. However, the complexity associated with reliable assurance of such separation increases with traffic density. Proper optimization of flight planning will seek to avoid fluctuations in air traffic controller (ATC) workload. Hence, there is a need for generation of a grid map that represents predicted aircraft traffic density as it evolves over time.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for generating a grid map that shows aircraft traffic intensity. The method comprises: collecting position data and an associated flight plan for each aircraft within a defined airspace volume; modeling the movement for each aircraft based on the latest observed position and the flight plan of the aircraft; dividing the defined airspace volume into a grid pattern comprising a plurality of cubes with defined spatial and time resolution periods; assigning each aircraft to a cube based on the aircraft's modeled movement over future time resolution periods; calculating a value for the number of assigned aircraft to each cube of the grid over future time resolution periods; calculating the ratio of the value of the number of assigned aircraft to a pre-determined air traffic control (ATC) capacity for the defined airspace volume over future time resolution periods; determining the suitability of the defined airspace volume for planned aircraft traffic based on the calculated ratios of the number of assigned aircraft to ATC capacity for each cube within the defined airspace volume; and displaying a traffic intensity map that reflects the suitability of the defined airspace volume for planned aircraft traffic.

A system is provided for generating a grid map that shows aircraft traffic intensity. The system comprises: a data source that provides position information for each aircraft within a defined airspace volume; a data source that provides a flight plan for each aircraft within the defined airspace volume; a data source that provides capacity limitations for the defined airspace volume; and a server-based processor that collects the position information, the flight plans and the capacity limitations from each respective data source, where the processor, models the movement for each aircraft based on the latest observed position and the flight plan of the aircraft, divides the defined airspace volume into a grid pattern comprising a plurality of cubes with defined spatial and time resolution periods, assigns each aircraft within the defined airspace volume to a cube based on the aircraft's modeled movement over future time resolution periods, calculates a value for the number of assigned aircraft to each cube of the grid over future time resolution periods, calculates the ratio of the value of the number of assigned aircraft to the capacity limitations for each cube over future time resolution periods, determines the suitability of the defined airspace volume for planned aircraft traffic based on the calculated ratios, and generates a traffic intensity map that reflects the suitability of the defined airspace volume for planned aircraft traffic; and a retrievable electronic database that stores the ratio of the value of the number of assigned aircraft to the capacity limitations for later historical analysis of aircraft traffic patterns.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a diagram of a grid pattern for defined airspace volume in accordance with one embodiment;

FIG. 2 shows a flowchart for a method for generating a grid map that shows air traffic intensity in accordance with one embodiment; and

FIG. 3 shows a block diagram of a system for generating a grid map that shows aircraft traffic intensity in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A method and system for generating a grid map that represents aircraft traffic density has been developed. Some embodiments include collecting position data and an associated flight plan for each aircraft within a defined airspace volume. The movement of each aircraft is modeled based on its latest observed position in combination with the flight plan of the aircraft to determine the aircraft's intended trajectory. The defined airspace volume is divided into a grid pattern that includes a plurality of “cubes” that have defined spatial resolution as well as defined time resolution periods. Each aircraft is assigned to a specific cube based on its modeled movement over future time periods. In this manner, it is possible to calculate a value for the number of assigned aircraft to each cube of the grid over future time resolution periods. It is possible to further calculate a ratio of the number of aircraft present in a specific cube to a predetermined regulatory traffic density capacity for future time periods. This allows the suitability of the defined airspace volume to be determined for aircraft traffic patterns for each cube. This information may then be displayed on a traffic intensity map that reflects the suitability of the air traffic density.

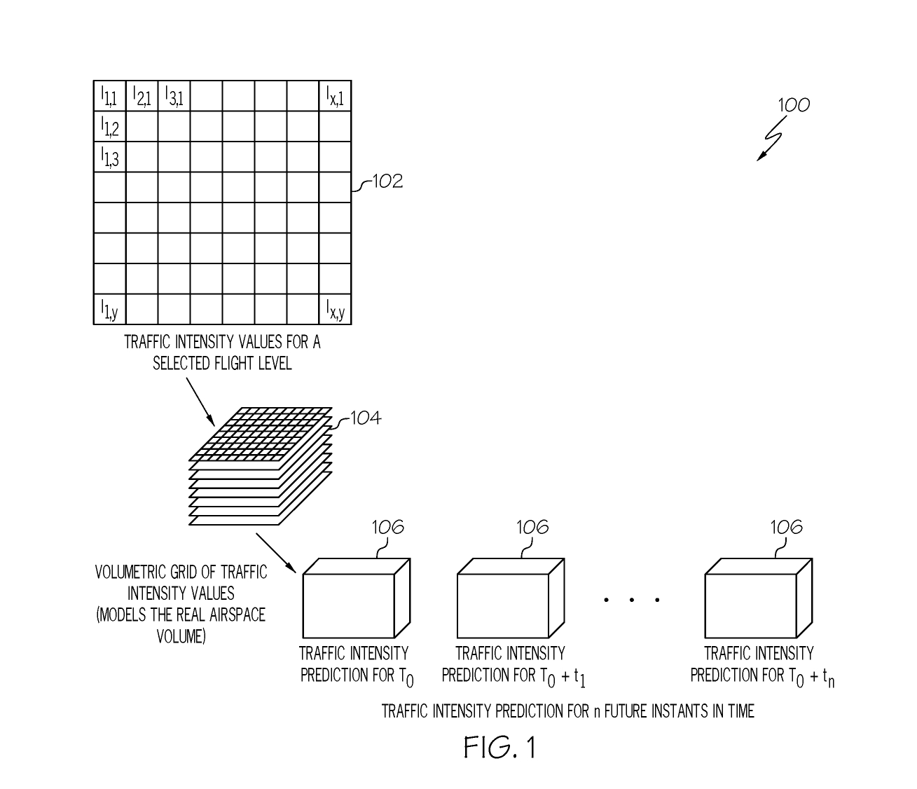

Turning now to FIG. 1, a diagram 100 is shown of a grid pattern for defined airspace volume in accordance with one embodiment. In this example, a square-shaped airspace volume is selected to be divided up into cubes. First, an overhead view 102 of the airspace volume for a single flight level is shown that is divided up into an 8×8 grid. It should be understood that a real life application will have a significantly higher number of squares in a grid. The 8×8 grid shown here is a simplified example for ease of reference. Each cube in the grid is identified by a specific identification number (I x,y). In this example, each cube is identified using a Cartesian coordinate system. Specifically, the x variable represents the column number while the y variable represents the row number. Consequently, the cube in the upper left-hand corner will have a coordinate's of “I _{1, 1}”, the cube directly below it will have a coordinate of “I _{1, 2}”, and the cube directly to its right will have a coordinate of “I _{2, 1}”. Next, an additional eight layers of the airspace volume are added to create a three-dimensional grid pattern of cubes 104. As with the example of the grid pattern, a real life application may utilize more flight levels based on traffic analysis. An additional variable (z) is added to cube's coordinates to indicate the appropriate level of the cube (I x., y, z). In this manner, each cube is readily identifiable in three dimensional space. Finally, each cube is given an initial resolution period (T₀) 106 to indicate the status of the traffic intensity within the cube at a specific time. Additional values in time are indicated by adding traffic intensity data predicted for future time periods to the initial value (T₀+T₁). Subsequent predicted traffic intensity values for “n” number of time intervals for future time periods may be added to this value as desired (T₀+Tₙ).

In other embodiments, alternative methods may be used to identify each cube and time period. For example, a standard numerical designation of a cube may be used that numbers each cube sequentially (e.g., 1, 2, 3 . . . ). The spatial size of the cubes may also vary and the sizes are adjustable. These adjustments may be made as required based on the performance parameters of the aircraft as well as the resolution requirements to monitor the air traffic intensity. In some embodiments, the spatial resolution value of the entire defined airspace volume may be between 10-50 nautical miles (NM). In a similar manner as the spatial resolution, the time resolution may also be adjusted based on performance parameters and precision requirements to monitor air traffic intensity. In some embodiments, the time resolution periods may be between 1-30 minutes between calculations of traffic intensity.

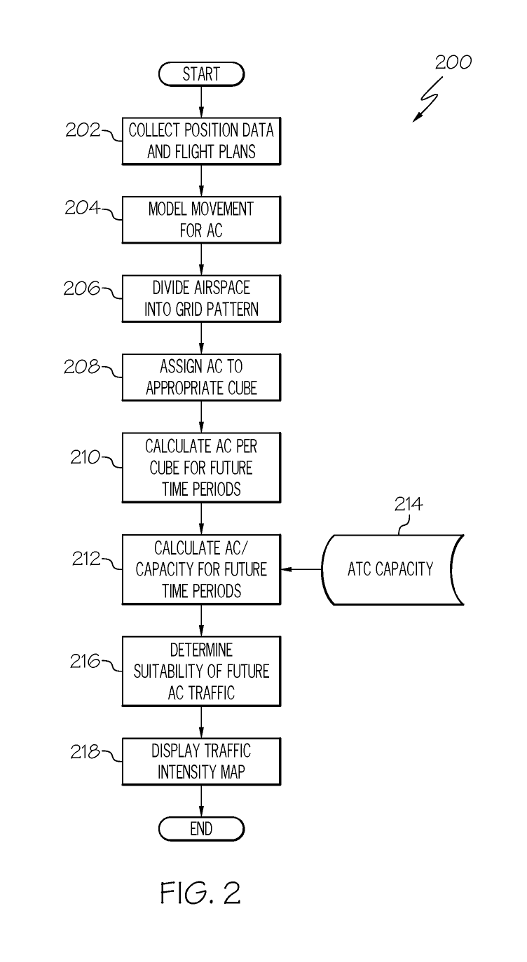

Turning now to FIG. 2, a flowchart 200 is shown for a method for generating a grid map that shows air traffic intensity in accordance with one embodiment. First, both position data and an associated flight plan for each aircraft within a defined airspace volume is collected 202. The aircraft position data and the associated flight plan may be available through various government infrastructures such as the Federal Aviation Administration's System Wide Information Management (FAA SWIM) system, the European Union's System Wide Information Management (EU SWIM) system, or various private companies such as Open-Sky Network, Flight Radar 24, Flight Aware, etc. These systems maintain databases that are sources of real time aircraft surveillance data which are often complemented with flight plan data for each aircraft. The flight plan and the latest observed position of the aircraft are used to model a movement trajectory 204 for each aircraft within the airspace volume. In alternative embodiments, extrapolation of an aircraft's current trajectory may be used to estimate future positions if a flight plan for the aircraft is not available from the data source or because a flight plan was not filed.

The defined airspace volume is then divided into a grid pattern comprising a plurality of cubes with each cube having a defined spatial and time resolution period 206. Each aircraft is assigned to a specific cube based on the aircraft's modeled movement over future time resolution periods 208. A value is calculated that reflects the number of assigned aircraft for each cube of the grid over future time resolution periods 210. A predetermined air traffic control (ATC) capacity for the airspace volume is retrieved from an outside data source 214 and used to calculate a ratio of the number of aircraft assigned for each cube with respect to the ATC capacity for the airspace volume over future time periods. In some embodiments, the ATC capacity may be continuously updated based on changing conditions such as weather, current traffic, or other conditions.

The suitability of the defined airspace volume for the planned aircraft traffic is determined based on the calculated ratios of the number of assigned aircraft to the ATC capacity within the defined airspace volume 214. A traffic intensity map is generated and displayed on a visual display device for the aircrew of the aircraft. In some alternative embodiments, the traffic intensity map reflects the suitability of the defined airspace volume for the planned aircraft traffic for each cube 216. In some embodiments, the traffic intensity map may depict the cubes of the gird in a three dimensional (3D) visual format 104 as shown previously in FIG. 1. The 3D format shows not only the status of each individual cube but also the status on other cubes in the area and their proximate relationship to each other. This allows a quick visual depiction of areas of air traffic congestion and the location of the congestion with respect to the current aircraft's position and its current flight path. In some embodiments, an unsuitable aircraft density within a specific cube may result in an automatic alert being generated for aircraft, and ATC authorities on the ground. Such alerts may be textual, aural and/or visual as depicted on the traffic intensity map. The visual alerts may be color coded in various embodiments to allow for quick recognition.

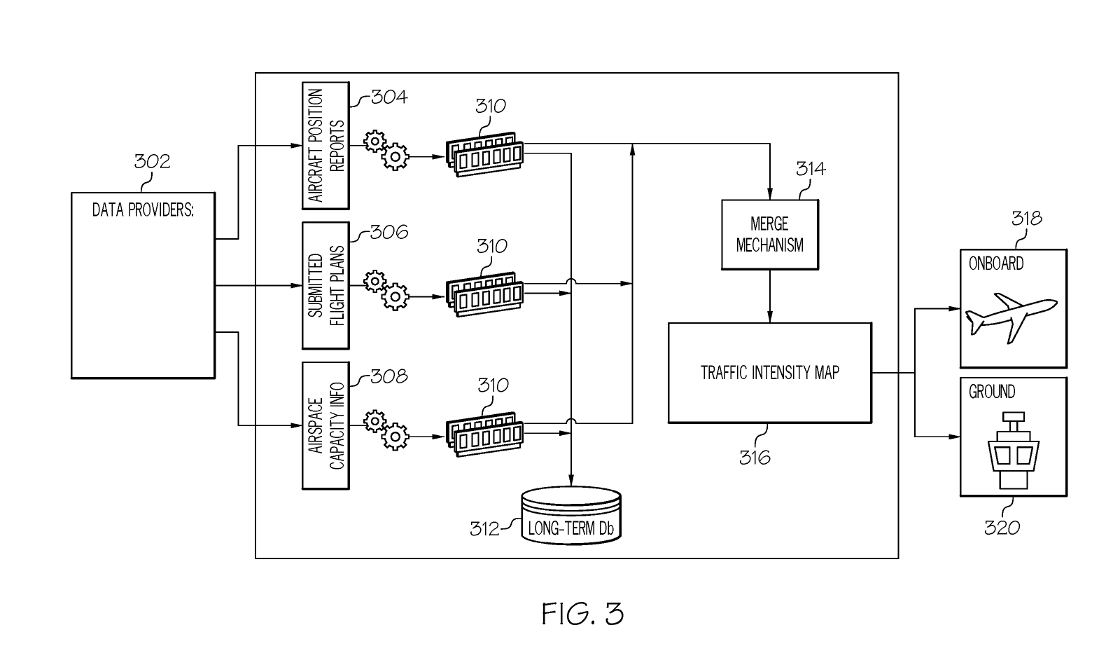

Turning now to FIG. 3, a block diagram 300 is shown of a system for generating a grid map that shows aircraft traffic intensity in accordance with one embodiment. First, a series of data providers 302 provides the system with aircraft position reports 304, approved flight plans 306 and airspace capacity limitations 308 for all aircraft within a defined airspace volume. The data providers 302 may include such systems as FAA SWIM, EU SWIM, Open Sky Network, Flight Radar 24, Flight Aware, or any other databases that provide aircraft surveillance data which may be complemented with flight plan data that are filed for individual aircraft.

This data 304, 306 and 308 is provided to a server-based processor 310 that merges the data 314 and models the movement of each aircraft based on the latest observed position and the flight plan of the aircraft. The defined airspace volume is divided into a grid pattern of a plurality of cubes with each cube having a defined spatial and time resolution. The processor then assigns each aircraft within the defined airspace volume to a cube based on the aircraft's modeled movement over future time resolution periods. The processor calculates a value for the number of assigned aircraft for each cube of the grid over future time resolution periods. A ratio is calculated of the value of the number of aircraft assigned to each cube with respect to the capacity limitations over future time resolution periods. The processor determines the suitability of the defined airspace volume for considered aircraft traffic based on the calculated ratios. This is part of a suitability assessment for a new flight which is the subject of flight-planning or being performed for a flight during a search for in-flight rerouting opportunities for trajectory optimization. The suitability is determined by a predetermined capacity as determined by an ATC authority. A traffic intensity map is then generated reflects the suitability of the defined airspace volume for the planned aircraft traffic. The traffic intensity map is provided to both the in-flight aircraft 318 as well as ground-based ATC authorities 320. In some embodiments, an unsuitable aircraft density within a specific cube may result in an automatic alert being generated for aircraft, and ATC authorities on the ground.

Additionally, the above described ratios are stored in a retrievable electronic database 312 for later retrieval for historical analysis of aircraft traffic patterns. When storing the values in the database 312, the respective values for each cube maybe averaged over time in both spatial resolution and time to reduce the quantization noise caused by the data. In some embodiments, the historical data as well as the present traffic intensity map 316 may be provided to an aircrew for use in preflight planning including the validation of a flight plan prior to submission. In other embodiments, the traffic intensity map may be used by ATC authorities for use in adjusting and optimizing air traffic patterns. Such adjustments may be made based on changing weather or air traffic patterns to avoid or minimize congestion. In still other embodiments, the traffic intensity map may be used to provide in-flight aircraft and ATC authorities situational awareness of ongoing air traffic intensity. This allows both the aircrew and the ATC sufficient warning to adjust air traffic flows to avoid congestion.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for generating a grid map that shows aircraft traffic intensity, comprising:
collecting position data and an associated flight plan for each aircraft within a defined airspace volume;
modeling the movement for each aircraft based on the latest observed position and the flight plan of the aircraft;
dividing the defined airspace volume into a grid pattern comprising a plurality of cubes with defined spatial and time resolution periods;
assigning each aircraft to a cube based on the aircraft's modeled movement over future time resolution periods;
calculating a value for the number of assigned aircraft to each cube of the grid over future time resolution periods;
calculating the ratio of the value of the number of assigned aircraft to a pre-determined air traffic control (ATC) capacity for the defined airspace volume over future time resolution periods;
determining the suitability of the defined airspace volume for planned aircraft traffic based on the calculated ratios of the number of assigned aircraft to ATC capacity within the defined airspace volume; and
displaying a traffic intensity map that reflects the suitability of the defined airspace volume for planned aircraft traffic.

2. The method of claim 1, further comprising:
storing the ratio of the value of the number of assigned aircraft to a predetermined ATC capacity for the defined airspace volume over future time resolution periods in a retrievable electronic database for later historical analysis of aircraft traffic patterns.

3. The method of claim 1, where the defined airspace volume has a spatial resolution value between 10-50 nautical miles (NM).

4. The method of claim 1, where the time resolution periods have a time resolution value between 1-30 minutes.

5. The method of claim 1, where the defined airspace volume and the time resolution periods are adjustable.

6. The method of claim 5, where the defined airspace volume and the time resolution periods are adjusted on precision requirements for the traffic intensity map.

7. The method of claim 5, where the defined airspace volume and the time resolution periods are adjusted based on performance parameters of the aircraft.

8. The method of claim 1, where the ATC capacity is continuously updated.

9. The method of claim 8, where the ATC capacity is continuously updated based upon weather conditions.

10. The method of claim 1, where the traffic intensity map is provided to an aircrew for use in pre-flight planning.

11. The method of claim 1, where the traffic intensity map is provided to ATC authorities for use in optimizing air traffic patterns.

12. The method of claim 1, where the traffic intensity map is provided to an in-flight aircraft to provide situational awareness of air traffic intensity.

13. The method of claim 1, where the traffic intensity map is provided to an in-flight aircraft for use in a trajectory optimization process.

14. The method of claim 1, where the traffic intensity map is provided to a ground system for use in flight planning.

15. A system for generating a grid map that shows aircraft traffic intensity, comprising:
a data source that provides position information for each aircraft within a defined airspace volume;
a data source that provides a flight plan for each aircraft within the defined airspace volume;
a data source that provides capacity limitations for the defined airspace volume; and
a server-based processor that collects the position information, the flight plans and the capacity limitations from each respective data source, where the processor,
models the movement for each aircraft based on the latest observed position and the flight plan of the aircraft,
divides the defined airspace volume into a grid pattern comprising a plurality of cubes with defined spatial and time resolution periods,
assigns each aircraft within the defined airspace volume to a cube based on the aircraft's modeled movement over future time resolution periods,
calculates a value for the number of assigned aircraft to each cube of the grid over future time resolution periods,
calculates the ratio of the value of the number of assigned aircraft to the capacity limitations for each cube over future time resolution periods,
determines the suitability of the defined airspace volume for planned aircraft traffic based on the calculated ratios, and
generates a traffic intensity map that reflects the suitability of the defined airspace volume for planned aircraft traffic;
a visual display that depicts the traffic intensity map to an aircrew member of the aircraft; and
a retrievable electronic database that stores the ratio of the value of the number of assigned aircraft to the capacity limitations for later historical analysis of aircraft traffic patterns.

16. The system of claim 15, the data source that provides position information and a flight plan for each aircraft is FAA SWIM.

17. The system of claim 15, the data source that provides position information and a flight plan for each aircraft is EU SWIM.

18. The system of claim 15, where the data source that provides capacity limitations is an air traffic control (ATC) authority.

19. The system of claim 15, where the capacity limitations are continuously updated by the data source based on weather conditions.
